(19) United States
(12) Patent Application Publication
(10) Pub. No.: US 2010/0256287 A1
(43) Pub. Date: Oct. 7, 2010

(54) RADICALLY CROSS-LINKABLE POLYMER COMPOSITIONS CONTAINING EPOXY-FUNCTIONAL COPOLYMERS

(75) Inventors: Thomas Kohler, Kastl (DE); Rene Grawe, Landshut (DE)

Correspondence Address: RATNERPRESTIA, P.O. BOX 980, VALLEY FORGE, PA, 19482, US

(73) Assignee: Wacker Chemie AG, Munchen (DE)

(21) Appl. No.: 12/746,035

(22) PCT Filed: Dec. 1, 2008
(86) PCT No.: PCT/EP08/66531

§ 371 Date: Jun. 3, 2010

(30) Foreign Application Priority Data
Dec. 3, 2007 (DE) 10 2007 055 692.8

(51) Int. Cl. C08L 33/04

(52) U.S. Cl. 524/517; 525/208

(57) ABSTRACT

The invention relates to radically cross-linkable polymer compositions containing one or more radically cross-linkable polymers, one or more ethylenically unsaturated monomers (reactive monomers), optionally initiators, optionally filling material, and optionally other additives. The invention is characterised in that additionally one or more vinyl halogenid-free, epoxy-functional vinylester-copolymers (epoxy-functional copolymers) are contained in said compositions.

### CROSS REFERENCE TO RELATED APPLICATIONS

This application is the national stage filing of PCT application number EP2008/066531, filed Dec. 1, 2008, and claims priority of German patent application number 102007055692.8, filed Dec. 3, 2007, the entireties of which applications are incorporated herein by reference.

### FIELD OF THE INVENTION

The invention relates to polymer compositions cross-linkable by a free-radical mechanism, comprising epoxy-functional copolymers, to processes for producing these, and also to the composite components obtainable via curing of the abovementioned polymer compositions, and to the use of the epoxy-functional copolymers as low-profile additive.

### BACKGROUND OF THE INVENTION

Production of composite components often uses polymer compositions crosslinkable by a free-radical mechanism, based on, for example, unsaturated polyester resins (UP resins). Unsaturated polyester resins are obtainable via polycondensation of dicarboxylic acids or dicarboxylic anhydrides with polyols. The polymer compositions crosslinkable by a free-radical mechanism also comprise monomers having ethylenically unsaturated groups, generally styrene. An example of the reason for addition of styrene to the polymer composition crosslinkable by a free-radical mechanism is to dissolve the crosslinkable polymer and to ensure that the polymer composition crosslinkable by a free-radical mechanism is flowable. Further constituents that are often also present in the polymer compositions crosslinkable by a free-radical mechanism are fiber materials, such as glass fibers, carbon fibers, or corresponding fiber mats (Fiber Reinforced Plastic composites—FPR composites), which reinforce the composite components obtainable via hardening of the polymer compositions crosslinkable by a free-radical mechanism.

One problem when these polymer compositions cross-linkable by a free-radical mechanism are processed to give composite components is volume shrinkage during the curing of the polymer composition. In order to reduce shrinkage during the hardening process, materials known as low-profile additives (LPAs) are added to the polymer compositions crosslinkable by a free-radical mechanism. Low-profile additives reduce shrinkage during hardening, dissipate intrinsic stresses, reduce microcracking, and facilitate compliance with manufacturing tolerances. The low-profile additives are usually thermoplastics, such as poly-styrene, polymethyl methacrylate, and in particular polyvinyl acetate, and these often also comprise carboxy-functional comonomer units. By way of example, therefore, U.S. Pat. No. 3,718,714 or DE-A 102006019686 recommend copolymers based on vinyl acetate and on ethylenically unsaturated carboxylic acids as LPAs for producing composite components based on unsaturated polyester resins.

EP-A 0075765 recommends producing composite components by using polymer compositions crosslinkable by a free-radical mechanism which comprise, as LPAs, polymers based on vinyl acetate or on alkyl acrylates, and which also comprise ethylenically unsaturated fatty acid esters, where these promote formation of composite components having surfaces of maximum smoothness or with minimum rippling. U.S. Pat. No. 4,525,498 discloses production of composite components by using polymer compositions crosslinkable by a free-radical mechanism comprising unsaturated polyester resin, LPA based on vinyl acetate or alkyl acrylate, and also saturated low-molecular-weight compounds bearing epoxy groups, where these amplify the shrinkage-reducing effect of the LPA during the hardening of the composition and improve the surface properties of the composite components. Addition of the low-molecular-weight compounds bearing epoxy groups did not significantly improve the mechanical properties of the composite components. Low-molecular-weight compounds moreover tend to migrate and are readily released from the composite components.

U.S. Pat. No. 4,284,736 recommends producing composite components by using polymer compositions crosslinkable by a free-radical mechanism comprising, as LPAs terpolymers based on vinyl esters, on glycidyl esters of unsaturated monocarboxylic acids, and also on at least 45% by weight of vinyl halides, based on the total weight of the respective terpolymer. The compositions described therein are characterized by good compatibility with not only organic but inorganic pigments, and also, after curing, by uniform pigmentation of the composite components. However, the use of polymers containing vinyl halide units is subject to criticism for environmental reasons, since by way of example these materials are susceptible to dehydrochlorination, and their disposal leads to the release of large quantities of hydrochloric acid.

Copolymers based on vinyl esters and on ethylenically unsaturated, epoxy-functional monomers are used in various application sectors. By way of example, EP-A 0897376 describes copolymers of this type as means of sizing for reinforcement processes involving glass fibers. The means of sizing involve aqueous compositions of saturated, thermoplastic polyurethanes, of vinyl acetate-glycidyl methacrylate copolymers, and also of silane coupling agents, where the use of these comprises their application in thin layers to the fibers.

### SUMMARY OF THE INVENTION

Against this background, the object was to find, for addition to polymer compositions crosslinkable by a free-radical mechanism, vinyl-halide-free additives which counteract volume shrinkage during hardening of said polymer compositions and which at the same time lead to composite components with an improved mechanical property profile, for example improved flexural strength, and which moreover in other respects do not exhibit the disadvantages mentioned above.

Surprisingly, the object was achieved by using polymer compositions crosslinkable by a free-radical mechanism comprising vinyl-halide-free, epoxy-functional vinyl ester copolymers.

### DETAILED DESCRIPTION OF THE INVENTION

The invention provides polymer compositions crosslinkable by a free-radical mechanism comprising one or more polymers crosslinkable by a free-radical mechanism, one or more ethylenically unsaturated monomers (reactive monomers), if appropriate initiators, if appropriate fillers, and also, if appropriate, further additions, characterized in that one or more vinyl-halide-free, epoxy-functional vinyl ester copolymers (epoxy-functional copolymers) is/are also present.

The epoxy-functional copolymers are obtainable via free-radical-initiated polymerization of

a) one or more vinyl esters and
b) one or more ethylenically unsaturated, epoxy-functional monomers and, if appropriate,
one or more further ethylenically unsaturated monomers differing from vinyl halides.

Preferred vinyl esters are vinyl esters of unbranched or branched carboxylic acids having from 1 to 18 carbon atoms. Particularly preferred vinyl esters are vinyl acetate, vinyl propionate, vinyl butyrate, vinyl 2-ethylhexanoate, vinyl laurate, and vinyl esters of α-branched monocarboxylic acids having from 5 to 13 carbon atoms, examples being vinyl pivalate, VeoVa9® or VeoVa10® (trademarks of Hexion) and mixtures of the abovementioned vinyl ester monomers, Vinyl acetate is most preferred.

It is preferable to use from 15 to 99.9% by weight of vinyl ester a), particularly from 20 to 99% by weight, based in each case on the total weight of the monomers for producing the epoxy-functional copolymers.

The ethylenically unsaturated, epoxy-functional monomers b) preferably have from 1 to 20 carbon atoms, particularly preferably from 1 to 10 carbon atoms, the arrangement of which can be linear or branched, open-chain or cyclic.

Examples of preferred ethylenically unsaturated, epoxy-functional monomers b) are glycidyl acrylate, glycidyl methacrylate (GMA) and allyl glycidyl ether; particular preference is given to glycidyl acrylate and glycidyl methacrylate; glycidyl methacrylate is most preferred.

It is preferable to use from 0.1 to 20% by weight, particularly from 0.2 to 15% by weight, of ethylenically unsaturated, epoxy-functional monomers b), based in each case on the total weight of the monomers for producing the epoxy-functional copolymers.

Other ethylenically unsaturated monomers that can be used for producing the epoxy-functional copolymers are one or more monomers selected from the group consisting of acrylic esters and methacrylic esters of unbranched or branched alcohols having from 1 to 20 carbon atoms, vinylaromatics, olefins, and dienes (monomers c)).

Preferred monomers c) from the group of the esters of acrylic acid or methacrylic acid are esters of unbranched or branched alcohols having from 1 to 15 carbon atoms. Particularly preferred acrylic esters or methacrylic esters are methyl acrylate, methyl methacrylate, ethyl acrylate, ethyl methacrylate, propyl acrylate, propyl methacrylate, n-, iso-, or tert-butyl acrylate, n-, iso-, and tert-butyl methacrylate, 2-ethylhexyl acrylate, norbornyl acrylate, isobornyl acrylate, stearyl acrylate. The acrylic esters or methacrylic esters to which most preference is given are methyl acrylate, ethyl acrylate, methyl methacrylate, n-, iso-, and tert-butyl acrylate, 2-ethylhexyl acrylate, and isobornyl acrylate.

Preferred dienes are 1,3-butadiene and isoprene. Examples of copolymerizable olefins are ethene and propene. Vinylaromatics that can be copolymerized are styrene and vinyltoluene.

It is preferable to use from 0 to 70% by weight, particularly from 0 to 50% by weight, of ethylenically unsaturated monomers c), based in each case on the total weight of the monomers for producing the epoxy-functional copolymers.

Other ethylenically unsaturated monomers that can be used for producing the epoxy-functional copolymers are one or more monomers selected from the group consisting of ethylenically unsaturated carboxylic acids, ethylenically unsaturated alcohols, ethylenically unsaturated sulfonic acids, and ethylenically unsaturated phosphonic acids (monomers d)). Preference is given to ethylenically unsaturated mono- and dicarboxylic acids having from 3 to 20 carbon atoms, ethylenically unsaturated alcohols having from 3 to 20 carbon atoms, vinylsulfonate, and vinylphosphonate. Particular preference is given to acrylic acid, methacrylic acid, crotonic acid, fumaric acid, maleic acid, 2-hydroxyethyl acrylate, 2-hydroxyethyl methacrylate, hydroxypropyl acrylate, or hydroxypropyl methacrylate.

The proportion of the monomers d) in the epoxy-functional copolymers is preferably from 0 up to 15% by weight, particularly preferably from 0 to 10% by weight, based in each case on the total weight of the epoxy-functional copolymers.

Preference is given to epoxy-functional copolymers obtainable by using the free-radical-initiated polymerization of one or more vinyl esters a) selected from the group consisting of vinyl acetate, vinyl pivalate, vinyl laurate, VeoVa9® and VeoVa10®, and

of one or more ethylenically unsaturated, epoxy-functional monomers b) selected from the group consisting of glycidyl acrylate, glycidyl methacrylate (GMA), and allyl glycidyl ether and, if appropriate,
of one or more monomers c) selected from the group of the (meth)acrylic esters, a particular example being methyl acrylate, methyl methacrylate, ethyl acrylate, n-, iso-, or tert-butyl acrylate, 2-ethylhexyl acrylate, isobornyl acrylate, or stearyl acrylate, from the group of the dienes, a particular example being isoprene or 1,3-butadiene, from the group of the olefins, a particular example being ethene, propene, or styrene and, if appropriate,
of one or more monomers d) selected from the group consisting of acrylic acid, methacrylic acid, crotonic acid, fumaric acid, maleic acid, 2-hydroxyethyl acrylate, 2-hydroxyethyl methacrylate, hydroxypropyl acrylate, and hydroxypropyl methacrylate.

Particular preference is given to epoxy-functional copolymers based on vinyl acetate and on one or more monomers b), a particular example being glycidyl methacrylate, and also, if appropriate, vinyl laurate, acrylic acid, or crotonic acid, in the above-mentioned amounts.

The epoxy-functional copolymers preferably comprise, per 1000 monomer units, ≧1, particularly preferably from 1 to 200, and most preferably from 10 to 150, epoxy-functional monomer units.

The molar masses Mw of the epoxy-functional copolymers are preferably ≧6500 g/mol, particularly preferably from 6500 to 1 500 000 g/mol, very particularly preferably from 6500 to 1 000 000 g/mol, and most preferably from 10 000 to 800 000 g/mol.

The distribution of the epoxy-functional monomer units in the epoxy-functional copolymers is preferably random, and it is therefore preferable that the epoxy-functional copolymers have not been grafted with epoxy-functional monomers or compounds.

The epoxy-functional copolymers are produced by free-radical bulk, suspension, emulsion, or solution polymerization processes involving the monomers a) and b), and also, if appropriate, the monomers c) to d), in the presence of free-radical initiators—for example as described in EP-A 1812478 or DE-A 10309857.

Suitable, preferred and, respectively, particularly preferred reactive monomers are the same as the monomers that are suitable, preferred and, respectively, particularly preferred for the polymerization process for producing the epoxy-functional copolymers. Very particularly preferred reactive monomers are styrene, methyl methacrylate, methyl acrylate, and butyl acrylate. Styrene is the most preferred reactive monomer.

Preferred polymers crosslinkable by a free-radical mechanism are unsaturated polyester resins or vinyl ester resins.

The unsaturated polyester resins are reaction products of one or more dicarboxylic acids, or of one or more dicarboxylic anhydrides, with one or more polyols. Production of the unsaturated polyester resins is known to the person skilled in the art.

The dicarboxylic acids or the dicarboxylic anhydrides preferably have from 2 to 20 carbon atoms, particularly preferably from 4 to 20 and most preferably from 4 to 10. The unsaturated polyester resins contain at least one ethylenically unsaturated dicarboxylic acid or at least one ethylenically unsaturated dicarboxylic anhydride. Preferred ethylenically unsaturated dicarboxylic acids or dicarboxylic anhydrides are maleic acid, maleic anhydride, fumaric acid, methylmaleic acid, and itaconic acid. Particular preference is given to maleic acid, maleic anhydride, and fumaric acid.

In addition to the ethylenically unsaturated dicarboxylic acids or dicarboxylic anhydrides, it is possible to use saturated dicarboxylic acids or anhydrides. Examples of suitable saturated acids or dicarboxylic anhydrides are orthophthalic acid, isophthalic acid, phthalic anhydride, terephthalic acid, hexahydrophthalic acid, adipic acid and succinic acid.

Suitable polyols preferably have from 2 to 20 carbon atoms, particularly preferably from 2 to 10. Polyols preferably bear from 2 to 3 alcohol groups, particularly preferably 2. Examples of suitable polyols are ethylene glycol, diethylene glycol, propylene glycol, dipropylene glycol, butylene glycol, neopentyl glycol, glycerol, and 1,1,1-trimethylolpropane.

The molar masses Mw of the unsaturated polyester resins are preferably from 500 to 10 000 g/mol, particularly preferably from 500 to 6000 g/mol, and most preferably from 1000 to 6000 g/mol.

Vinyl ester resins are reaction products produced via polyaddition processes or esterification reactions of phenol derivatives and of ethylenically unsaturated mono- or dicarboxylic acids or dicarboxylic anhydrides having from 3 to 20 carbon atoms, examples being acrylic acids or methacrylic acids. Preferred phenol derivatives are bisphenol A and phenol novolak. Production of the vinyl ester resins is known to the person skilled in the art.

Examples of suitable initiators are tert-butyl perbenzoate, tert-butyl 2-ethylperoxyhexanoate, tert-butyl peroxypivalate, tert-butyl peroxyneodecanoate, dibenzoyl peroxide, tert-amyl peroxypivalate, di(2-ethylhexyl) peroxydicarbonate, 1,1-bis(tert-butyl-peroxy)-3,3,5-trimethylcyclohexane, di(4-tert-butyl-cyclohexyl) peroxydicarbonate, and azobisisobutyronitrile.

Examples of suitable fillers are talc, aluminum hydroxide, kaolin, calcium carbonate, dolomite, glass beads, or glass fibers, quartz, aluminum oxide, or barium sulfate.

It is preferable that the polymer compositions cross-linkable by a free-radical mechanism comprise from 30 to 60 parts by weight of polymers crosslinkable by a free-radical mechanism, from 5 to 40 parts by weight of epoxy-functional copolymers, from 30 to 160 parts by weight of reactive monomers, if appropriate from 0.5 to 2 parts by weight of initiator, if appropriate fillers, for example from 25 to 100 parts by weight of glass fiber, or from 50 to 200 parts by weight of calcium carbonate and, if appropriate, further additives, for example from 0.5 to 3 parts by weight of mold-release agent, such as zinc stearate, and also, if appropriate, further added materials, such as pigments, thickeners, and flame-retardant additions.

The polymer compositions crosslinkable by a free-radical mechanism can moreover comprise further polymers, examples being polymers known to act as low-profile additive, e.g. polyvinyl acetate, or carboxy-functional polyvinyl acetate, or polymethyl methacrylate. The proportion of the further polymers is from 0 to 100% by weight, preferably from 0 to 50% by weight, based in each case on the amount by weight of epoxy-functional copolymers in the respective polymer composition crosslinkable by a free-radical mechanism.

The invention further provides processes for producing the polymer compositions crosslinkable by a free-radical mechanism, which use mixing of one or more polymers crosslinkable by a free-radical mechanism, of one or more ethylenically unsaturated monomers (reactive monomers) and, if appropriate, of initiators and, if appropriate, of fillers, and also, if appropriate, of further additions, characterized in that one or more vinyl-halide-free, epoxy-functional vinyl ester copolymers (epoxy-functional copolymers) is/are also admixed.

The epoxy-functional copolymers and the polymers crosslinkable by a free-radical mechanism are generally dissolved separately or together in reactive monomers, if appropriate in combination with further polymers, and, if appropriate, are mixed with further additives, such as fillers, thickeners, initiators, and processing aids. If the epoxy-functional copolymers, or the polymers crosslinkable by a free-radical mechanism, are dissolved in reactive monomers, the form in which the polymers crosslinkable by a free-radical mechanism are used is preferably that of a solution of strength from 50 to 70% in reactive monomers, and the form in which the epoxy-functional copolymers are used is preferably that of a solution of from 30 to 50% strength in reactive monomers.

The mixing of the components for producing the polymer compositions crosslinkable by a free-radical mechanism can be carried out with use of the familiar apparatuses known to the person skilled in the art, examples being reactors, stirred tanks, or mixers, and examples of stirrers being blade stirrers, anchor stirrers, or paddle stirrers.

The invention further provides composite components obtainable via curing of the polymer compositions crosslinkable by a free-radical mechanism.

The polymer compositions crosslinkable by a free-radical mechanism are preferably cured at temperatures of ≧20° C., particularly preferably from 20 to 200° C., and most preferably from 20 to 165° C. It is preferable that the curing process takes place in the presence of one or more initiators via free-radical-initiated polymerization. During the curing process at the respective temperature, the polymer compositions crosslinkable by a free-radical mechanism are, if appropriate, pressed by using pressures of ≧1 mbar, particularly preferably from 1 to 200 000 mbar, and most preferably from 1000 to 200 000 mbar.

Any of the familiar production processes can be used to obtain the composite components from the polymer compositions crosslinkable by a free-radical mechanism, examples being Sheet Molding Compound Technology (SMC), Bulk Molding Compound Technology (BMC), Resin Transfer Molding (RTM), or Resin Injection Molding (RIM).

It is preferable that the composite components are produced by means of BMC (Bulk Molding Compound) technology or SMC (Sheet Molding Compound) technology.

In the BMC process, the solutions, in reactive monomer, of the polymers crosslinkable by a free-radical mechanism are mixed with the epoxy-functional copolymers and, if appropriate, with the further components, such as the initiator, filler, mold-release agent, or further polymers, low-profile additives, or added materials, to give a paste, and then, if appropriate, glass fibers are admixed, and the resultant polymer compositions crosslinkable by a free-radical mechanism are then hardened to give the composite component by using pressure and heat. This technology is used by way of example to produce reflectors for automobile head-lamps.

In the SMC process, by analogy with the BMC process, a polymer composition crosslinkable by a free-radical mechanism is produced in the form of a paste from a solution, in reactive monomer, of the polymers cross-linkable by a free-radical mechanism, and from the epoxy-functional copolymer and, if appropriate, from the further components, such as initiator, filler, and mold-release agent, and from further polymers, low-profile-additives, or added materials, and is applied to a polyamide film. Glass fiber is then, if appropriate, scattered onto said layer, and then, if appropriate, a further layer of the paste is applied, and finally a further polyamide film is used as covering. This sandwich sheet is then peeled away from the film, cut into sections, and pressed to give composite components, with the use of heat. Composite components produced by means of this technology are used, for example, as tailgates of automobiles.

The composite components of the invention have advantageous performance characteristics, an example being improved mechanical strength, in particular high flexural strength. Mechanical strength can be raised by using epoxy-functional copolymers having a relatively large number of epoxy-functional monomer units and/or having relatively high molar mass Mw. The epoxy-functional copolymers moreover act as low-profile additives during the production of the composite components.

The invention further provides the use of the epoxy-functional copolymers as low-profile additives (LPAs).

The following examples serve for further explanation of the invention, without in any way restricting the same.

### Production of the Epoxy-Functional Copolymers:

### Inventive Example 1

307.0 g of ethyl acetate, 50.0 g of vinyl acetate, 0.5 g of glycidyl methacrylate, and 1.6 g of PPV (tert-butyl perpivalate, 75% strength solution in aliphatics) were used as initial charge in a 2 l glass mixing vessel with anchor stirrer, reflux condenser, and metering equipment. The initial charge was then heated to 70° C. under nitrogen, using a stirrer rotation rate of 200 rpm. Once the internal temperature had reached 70° C., 1150.0 g of vinyl acetate, 12.0 g of glycidyl methacrylate, and initiator solution (14.8 g of PPV) were metered into the mixture. The monomer solution was metered into the mixture within a period of 240 minutes the initiator solution was metered into the mixture within a period of 300 minutes. Once the initiator feeds had ended, polymerization was continued at 80° C. for a further 2 hours. A clear polymer solution was obtained, with 79% by weight solids content. The ethyl acetate was removed by distillation in vacuo at elevated temperature. The dried film derived from ethyl acetate solution (layer thickness 70 micrometers) was clear. The glycidyl methacrylate content of the copolymer was 1% by weight, based on the total mass of the monomers used.

### Inventive Example 2

By analogy with the procedure of inventive example 1, a copolymer was produced from 97% by weight of vinyl acetate and 3% by weight of glycidyl methacrylate. Table 1 lists the properties of the polymer.

### Inventive Example 3

By analogy with the procedure of inventive example 1, a copolymer was produced from 97% by weight of vinyl acetate and 3% by weight of glycidyl methacrylate. Unlike in inventive example 1, however, 247 g of isopropanol were used instead of ethyl acetate. Table 1 lists the properties of the polymer.

### Inventive Example 4

By analogy with the procedure of inventive example 1, a copolymer was produced from 95% by weight of vinyl acetate and 5% by weight of glycidyl methacrylate. Table 1 lists the properties of the polymer.

### Inventive Example 5

By analogy with the procedure of inventive example 1, a copolymer was produced from 94% by weight of vinyl acetate and 6% by weight of glycidyl methacrylate. Table 1 lists the properties of the polymer.

### Inventive Example 6

By analogy with the procedure of inventive example 1, a copolymer was produced from 90% by weight of vinyl acetate and 10% by weight of glycidyl methacrylate, Table 1 lists the properties of the polymer.

### Inventive Example 7

By analogy with the procedure of inventive example 1, a copolymer was produced from 88% by weight of vinyl acetate and 12% by weight of glycidyl methacrylate Table 1 lists the properties of the polymer.

TABLE 1
Compositions and properties of the epoxy-functional copolymers

| | VAc^{a)} | GMA^{a)} | | | | |
|---|---|---|---|---|---|---|
| Inv. | [% by | [% by | Höppler^{c)} | K | Mw^{e)} | |
| ex. | wt.]^{b} | wt.]^{b} | [mPas] | value^{d)} | [kg/mol] | PD^{f)} |
| 1 | 99 | 1 | 5.1 | 40.1 | — | — |
| 2 | 97 | 3 | 7.4 | 45.1 | 138 | 5 |
| 3 | 97 | 3 | 2.2 | 24.8 | 25 | 2 |
| 4 | 95 | 5 | 8.6 | 44.7 | 149 | 7 |
| 5 | 94 | 6 | 9.1 | 48.2 | 185 | 8 |
| 6 | 90 | 10 | 11.7 | 54.1 | 290 | 8 |
| 7 | 88 | 12 | 12.1 | 55.4 | 350 | 9 |

^{a)}VAc: vinyl acetate; GMA: glycidyl methacrylate
^{b)}The % by wt. data are based on the total weight of the monomers.
^{c)}Höppler: Höppler viscosity to DIN 53015 (10% in ethyl acetate, 20° C.)
^{d)}K value: determined to DIN EN ISO 1628-2 (1% by wt. in acetone).
^{e)}Mw: Molar mass Mw (weight-average) determined by means of SEC “size exclusion chromatography”, polystyrene standard, THF, 60° C.
^{f)}Polydispersity (Mw/Mn).

### Production of the Composite Components:

A mixture was produced from 100 parts by weight of an unsaturated polyester resin (orthophthalic acid-maleic anhydride resin, dissolved at 65% strength in styrene) with 1 part by weight of a cobalt accelerator (NL 49-P from Akzo Nobel), 1.5 parts by weight of an initiator (Butanox M 50 from Akzo Nobel) and, if appropriate, 2 parts by weight of polymer addition (table 2), and poured into a mold after intimate mixing. Hardening for 24 hours at room temperature, 24 hours at 65° C., and 2 h at 100° C. gave the test specimen (length/width/thickness=100 mm/15 mm/2 mm). Table 2 provides a more detailed characterization of these test specimens.

### Testing of the Mechanical Properties of the Composite Components:

TABLE 2
Effect of the epoxy-functional copolymers on the
mechanical properties of the composite components

| | | GMA^{a)} | Mw^{b)} | FS^{c)} |
|---|---|---|---|---|
| Ex. | Polymer addition | [% by wt.] | [kg/mol] | [MPa] |
| comp. 8 | — | — | 5 | 15 |
| comp. 9 | Vinyl acetate homopolymer | — | 15 | 10 |
| 10 | Vinyl acetate-glycidyl | 3 | 138 | 33 |
| | methacrylate copolymer | | | |
| | of inventive example 2 | | | |
| 11 | Vinyl acetate-glycidyl | 3 | 25 | 18 |
| | methacrylate copolymer | | | |
| | of inventive example 3 | | | |
| 12 | Vinyl acetate-glycidyl | 6 | 149 | 38 |
| | methacrylate copolymer | | | |
| | of inventive example 4 | | | |
| 13 | Vinyl acetate-glycidyl | 12 | 350 | 45 |
| | methacrylate copolymer | | | |
| | of inventive example 7 | | | |

^{a)}GMA: glycidyl methacrylate; the % by wt. data are based on the total weight of the copolymer.
^{b)}Mw: Molar mass Mw (weight-average) determined by means of SEC “size exclusion chromatography”, polystyrene standard, THF, 60° C.
^{c)}FS: Flexural strength: determined to DIN EN ISO 14125.

The flexural strength of the composite components was determined on the test specimens to EN ISO 14125. Table 2 lists the test results for the various test specimens.

From the comparative examples it is apparent that the test specimen comp. 9 modified with a vinyl acetate homopolymer exhibits considerably poorer flexural strength when compared with the unmodified test specimen comp. 8. In contrast, the addition of the epoxy-functional copolymer of inventive example 3 led to an increase of the flexural strength of the test specimen in inventive example 10. Examples 10 to 13 provide evidence that a further increase in the number of the epoxy-functional monomer units and, respectively, in the molar mass Mw of the epoxy-functional copolymers can also considerably increase the flexural strengths of the test specimens.

### Testing of the Action of the Epoxy-Functional Copolymers as LPAs:

TABLE 3
Formulation for composite components

| Type | Raw material | Pts. by wt. |
|---|---|---|
| Orthophthalic acid- | UP resin (65% strength | 65.5 |
| maleic anhydride resin | in styrene) | |
| (UP resin) in styrene | | |
| LPA1 or LPA2 in styrene | LPA (40% strength | 30.0 |
| | in styrene) | |
| Styrene | Monomer | 4.5 |
| Trigonox ® C | Initiator | 1.5 |
| Byk ®-W 996 | Wetting and | 2.9 |
| | dispersing additive | |
| p-Benzoquinone solution | Inhibitor (10% in MMA) | 0.7 |
| Akzo Nobel NL-49 | Accelerator (1% strength | 1.1 |
| solution | Co in ester) | |
| Byk ® 9076 | Wetting and | 0.5 |
| | dispersing additive | |
| Carbon black 9257-45 | Black color paste | 10.0 |
| Millicarb ® OG | Filler | 200.0 |
| Subtotal | | 316.7 |
| Luvatol ® MK35 in UP | Thickener (35% strength | 1.5 |
| resin | MgO in UP resin) | |
| Vetrotex P204 | Glass fiber | 85.9 |

The low-profile additives used comprised:

### LPA1 (Comparison):

Copolymer of vinyl acetate and 1% by weight of crotonic acid (molar mass Mw=175 kg/mol).

### LPA2:

Epoxy-functional copolymer of inventive example 4.

The raw materials listed in table 3 were kneaded to give a paste. Shortly prior to processing, Luvatol MK 35, a thickener, was also incorporated by stirring. A manual laminate was then produced with the paste and with the glass fibers and was processed to give an SMC. The product was stored for 3 days at 20° C. and 50% humidity. It was then pressed at 160° C. in a familiar SMC press to give a composite component.

Shrinkage was determined after cooling of the press, and volume change was determined in percent (table 4). Minus values indicate that the composite component was larger than the original mold.

TABLE 4
Dimensional changes of the composite components

| | x | | | y | | |
|---|---|---|---|---|---|---|
| | Dimensional | | Shrink- | Dimensional | | Shrink- |
| | change | Length | age | change | Length | age |
| | [mm] | [mm] | [‰] | [mm] | [mm] | [‰] |
| LPA1 | 0.397 | 457.392 | −0.42 | 0.456 | 457.451 | −0.55 |
| LPA2 | 0.342 | 457.344 | −0.33 | 0.411 | 457.402 | −0.43 |

From table 4, it is apparent that the epoxy-functional copolymers and conventional carboxy-functional poly-vinyl acetates have comparable suitability as LPAs. In the formulation, both bring about an expansion on pressing. Addition of the epoxy-functional copolymers of the invention moreover also brings about an improvement in the mechanical properties of composite components, as is apparent from table 2. Another effect of the molar mass and of the fixing of the epoxy-functional copolymers to the composite components by way of the epoxy groups is that the epoxy-functional copolymers cannot migrate to the surface of the composite components. This reduces the extent of problems in the painting of the composite components, for example the occurrence of defects or poor-quality paint surface.

What is claimed is:

1. A polymer composition crosslinkable by a free-radical mechanism, comprising one or more polymers crosslinkable by a free-radical mechanism, one or more ethylenically unsaturated monomers (reactive monomers), if appropriate initiators, if appropriate fillers, and also, if appropriate, further additions,
characterized in that
one or more vinyl-halide-free, epoxy-functional vinyl ester copolymers (epoxy-functional copolymers) is/are also present.

2. The polymer composition crosslinkable by a free-radical mechanism, as claimed in claim 1, characterized in that the epoxy-functional copolymers are obtainable via free-radical-initiated polymerization of
a) one or more vinyl esters and
b) one or more ethylenically unsaturated, epoxy-functional monomers and, if appropriate,
one or more further ethylenically unsaturated monomers differing from vinyl halides.

3. The polymer composition crosslinkable by a free-radical mechanism, as claimed in claim 2, characterized in that the ethylenically unsaturated, epoxy-functional monomers b) have from 1 to 20 carbon atoms, the arrangement of which can be linear or branched, open-chain or cyclic.

4. The polymer composition crosslinkable by a free-radical mechanism, as claimed in claim 2 or 3, characterized in that the ethylenically unsaturated, epoxy-functional monomers b) are glycidyl acrylate, glycidyl methacrylate (GMA), or allyl glycidyl ether.

5. The polymer composition crosslinkable by a free-radical mechanism, as claimed in any of claims 2 to 4, characterized in that the proportion used of the ethylenically unsaturated, epoxy-functional monomers b) is from 0.1 to 20% by weight, based on the total weight of the monomers for producing the epoxy-functional copolymers.

6. The polymer composition crosslinkable by a free-radical mechanism, as claimed in any of claims 1 to 5, characterized in that the molar mass Mw of the epoxy-functional copolymers is ≧6500 g/mol.

7. The polymer composition crosslinkable by a free-radical mechanism, as claimed in any of claims 1 to 6, characterized in that the polymers crosslinkable by a free-radical mechanism are unsaturated polyester resins or vinyl ester resins.

8. The polymer composition crosslinkable by a free-radical mechanism, as claimed in any of claims 1 to 7, characterized in that the reactive monomers are selected from the group consisting of vinyl esters, acrylic esters, and methacrylic esters, vinylaromatics, olefins, dienes, and vinyl halides.

9. A process for producing the polymer compositions crosslinkable by a free-radical mechanism, which uses mixing of one or more polymers crosslinkable by a free-radical mechanism, of one or more ethylenically unsaturated monomers (reactive monomers) and, if appropriate, of initiators and, if appropriate, of fillers, and also, if appropriate, of further additions, characterized in that one or more vinyl-halide-free, epoxy-functional vinyl ester copolymers (epoxy-functional copolymers) is/are also admixed.

10. A composite component obtainable via curing of the polymer compositions crosslinkable by a free-radical mechanism, as claimed in any of claims 1 to 8.

11. The use of the epoxy-functional copolymers of any of claims 2 to 6 as low-profile additives (LPAs).
